(19) United States
(12) Patent Application Publication
(10) Pub. No.: US 2026/0274146 A1
(43) Pub. Date: Sep. 17, 2026

(54) VALVE ASSEMBLY FOR BULK MATERIAL CONTAINER DISCHARGE

(71) Applicant: Michael Taylor, Riddleton, TN (US)

(72) Inventor: Michael Taylor, Riddleton, TN (US)

(21) Appl. No.: 19/673,830

(22) Filed: May 11, 2026

Related U.S. Application Data
(63) Continuation-in-part of application No. 18/750,559, filed on Jun. 21, 2024, now Pat. No. 12,649,406.
Application No. 18/750,559 is a division of application No. 18/097,741, filed on Jan. 17, 2023, now Pat. No. 12,043,162.

(51) Int. Cl. B60P 3/22; B60P 1/60; B65G 53/06; B65G 53/66

(52) U.S. Cl. CPC B60P 3/2245; B60P 1/60; B60P 3/225; B65G 53/06; B65G 53/66

(57) ABSTRACT

A valve assembly for controlling discharge of bulk material from a container includes an upper conical valve body having at least one aperture on an inclined surface thereof, and a lower conical valve body nested under and within the upper conical valve body, the lower conical valve body having at least one aperture on an inclined surface thereof. A tapered roller thrust bearing is disposed between the upper conical valve body and the lower conical valve body. The lower conical valve body comprises a ring gear portion configured to engage a toothed member to rotate the lower conical valve body relative to the upper conical valve body between an open position in which the apertures are aligned and a closed position in which the apertures are not aligned.

### CROSS-REFERENCE TO RELATED APPLICATIONS

This application is a continuation-in-part of U.S. application Ser. No. 18/750,559, titled “SYSTEM FOR TRANSPORT OF DRY BULK MATERIAL,” filed Jun. 21, 2024, which is a divisional of U.S. application Ser. No. 18/097,741, titled “SYSTEM FOR TRANSPORT OF DRY BULK MATERIAL,” filed Jan. 17, 2023, each of which is hereby incorporated by reference in its entirety.

### FIELD OF INVENTION

The present disclosure relates to valve assemblies for controlling discharge of bulk material from containers, and more particularly to a valve assembly comprising nested conical valve bodies with aligned apertures and a tapered roller thrust bearing to facilitate rotational movement between open and closed positions.

### BACKGROUND

Containers for bulk material within the scope of the present disclosure may for example include hoppers, silos, bins, flexible intermediate bulk containers (FIBCs), railcars, and other vessels designed to store and discharge granular, powdered, or particulate materials, to name but a few examples. These containers may typically have an interior surface that is at least partially inclined toward a discharge opening, directing the bulk material by gravity toward a valve or gate at the bottom of the container. The containers may be rigid structures fabricated from metal, fiberglass, or plastic, but containers within the scope of the present disclosure may also include flexible fabric-based vessels.

Containers as disclosed herein may include for example a discharge valve, which includes one or more movable components, that is used to control the release of bulk material based on operational demands. The discharge valve may be positioned at the lowest point of the container where the inclined interior surfaces converge, and the valve may be actuated manually or via automated control systems to open and close the discharge path.

Conventional discharge valves for bulk material containers may generally be categorized into slide gate valves, butterfly valves, rotary valves, and cone valves. Slide gate valves typically employ a flat plate that translates linearly across the discharge opening. Butterfly valves use a disc that rotates about a central shaft spanning the flow path. Rotary valves meter material through rotating pockets or vanes. Cone valves may use a vertically translating cone element to open and close an annular discharge gap.

One of the conventional challenges with slide gate and butterfly valves is that the actuation mechanism and structural components extend across or into the material flow path. The central shaft of a butterfly valve, for example, bisects the discharge opening and may cause material bridging or accumulation. Slide gates may experience binding or jamming when particulate material infiltrates the sliding interface. These obstructions in the flow path can reduce discharge efficiency and create areas where material accumulates and is not fully discharged.

Conventional cone valves may address some flow path obstruction concerns by using a conical element that lifts vertically to create an annular discharge gap. However, this configuration typically requires a central support structure or lifting mechanism that extends through the material column. The vertical translation of the cone element may also require substantial clearance below the container, increasing the overall height of the installation. Additionally, the annular discharge pattern of conventional cone valves may not provide uniform flow characteristics for all material types.

Another conventional challenge relates to the bearing and sealing arrangements in discharge valves. Valves that rotate or translate under the weight of bulk material may experience high friction forces that increase the actuation effort and accelerate wear. Conventional solutions may employ bushings, sleeve bearings, or ball bearings to reduce friction, but these bearing types may not be optimized for the combined axial and radial loading conditions present in conical valve geometries. The bearing arrangement may also affect the precision of the valve movement and the consistency of the seal between open and closed positions.

Operators of bulk material handling systems may find that conventional discharge valves require frequent maintenance, produce inconsistent flow rates, or fail to achieve complete material cleanout. The setup and adjustment of conventional valves to achieve a reliable seal may add time and complexity to installation. These operational difficulties may result in reduced productivity and increased costs associated with material handling operations.

### SUMMARY

This summary is provided to introduce a selection of concepts in a simplified form that are further described below in the detailed description. This summary is not intended to identify key features or essential features of the claimed subject matter, nor is it intended to be used as an aid in determining the scope of the claimed subject matter.

According to an aspect of the present disclosure, a valve assembly for controlling discharge of bulk material from a container is provided. The valve assembly includes an upper conical valve body including at least one aperture disposed on an inclined surface of the upper conical valve body. A lower conical valve body is nested under and within the upper conical valve body. The lower conical valve body includes at least one aperture disposed on an inclined surface of the lower conical valve body. A tapered roller thrust bearing is disposed between the upper conical valve body and the lower conical valve body. The lower conical valve body comprises a ring gear portion configured to engage a toothed member to rotate the lower conical valve body relative to the upper conical valve body between an open position in which the at least one aperture of the upper conical valve body is aligned with the at least one aperture of the lower conical valve body and a closed position in which the at least one aperture of the upper conical valve body is not aligned with the at least one aperture of the lower conical valve body.

According to other aspects of the present disclosure, the valve assembly may include one or more of the following features. The at least one aperture of the upper conical valve body and the at least one aperture of the lower conical valve body may each include a plurality of sides with rounded corners between each side. The at least one aperture of the upper conical valve body and the at least one aperture of the lower conical valve body may each include three sides with rounded corners between each side, and each aperture may be positioned such that one rounded corner is oriented toward an apex of the respective conical valve body. The upper conical valve body may include two apertures disposed on opposing inclined surfaces of the upper conical valve body, and the lower conical valve body may include two apertures disposed on opposing inclined surfaces of the lower conical valve body. The valve assembly may further comprise a circular mounting bracket disposed circumferentially around a base of the upper conical valve body and a base of the lower conical valve body, the circular mounting bracket including an engagement opening extending a portion of a circumference of the circular mounting bracket. The valve assembly may further comprise a circular holding bracket, wherein a flange of the upper conical valve body and a flange of the lower conical valve body are disposed between the circular holding bracket and the circular mounting bracket. The ring gear portion may include cogs extending a portion of a circumference of the ring gear portion, and at least a portion of the cogs may extend through the engagement opening of the circular mounting bracket to engage with the toothed member. The toothed member may be a rack. A lowest side of each aperture may be substantially parallel with a base of the respective conical valve body.

According to another aspect of the present disclosure, a container for bulk material is provided. The container comprises a container body having an interior surface, at least a portion of the interior surface being inclined toward a discharge opening in the container body. A valve assembly is disposed at the discharge opening. The valve assembly comprises an upper conical valve body including at least one aperture disposed on an inclined surface of the upper conical valve body. A lower conical valve body is nested under and within the upper conical valve body. The lower conical valve body includes at least one aperture disposed on an inclined surface of the lower conical valve body. A tapered roller thrust bearing is disposed between the upper conical valve body and the lower conical valve body. The lower conical valve body comprises a ring gear portion configured to engage a toothed member to rotate the lower conical valve body relative to the upper conical valve body between an open position in which the at least one aperture of the upper conical valve body is aligned with the at least one aperture of the lower conical valve body and a closed position in which the at least one aperture of the upper conical valve body is not aligned with the at least one aperture of the lower conical valve body.

According to other aspects of the present disclosure, the container may include one or more of the following features. The container body may be rigid. The container body may be flexible. The container may further comprise a circular mounting bracket and a circular holding bracket, wherein the valve assembly is disposed at a bottom wall of the container body, and the circular mounting bracket is disposed at or below the bottom wall. A bottom wall of the container body may be disposed between the circular mounting bracket and the circular holding bracket. The container may further comprise a mounting structure secured to an underside of the container body, the mounting structure supporting the valve assembly beneath the container body, the mounting structure comprising at least one of a circular holding bracket or a separate mounting ring.

According to another aspect of the present disclosure, a method of controlling discharge of bulk material from a container is provided. The method comprises providing a valve assembly including an upper conical valve body having at least one aperture and a lower conical valve body nested under and within the upper conical valve body, the lower conical valve body having at least one aperture, wherein a tapered roller thrust bearing is disposed between the upper conical valve body and the lower conical valve body. The method further comprises engaging a toothed member with a ring gear portion of the lower conical valve body. The method further comprises rotating the lower conical valve body relative to the upper conical valve body via the engagement between the toothed member and the ring gear portion, wherein the tapered roller thrust bearing facilitates the rotation, to move the valve assembly between an open position in which the at least one aperture of the upper conical valve body is aligned with the at least one aperture of the lower conical valve body and a closed position in which the at least one aperture of the upper conical valve body is not aligned with the at least one aperture of the lower conical valve body.

According to other aspects of the present disclosure, the method may include one or more of the following features. Rotating the lower conical valve body to the open position may include aligning apertures disposed on opposing inclined surfaces of the upper conical valve body with apertures disposed on opposing inclined surfaces of the lower conical valve body. A weight of the bulk material in the container may create a seal between the upper conical valve body and the lower conical valve body when the valve assembly is in the closed position. The method may further comprise actuating the toothed member via a controller to rotate the lower conical valve body. The method may further comprise manually actuating the toothed member to rotate the lower conical valve body.

The foregoing general description of the illustrative embodiments and the following detailed description thereof are merely exemplary aspects of the teachings of this disclosure and are not restrictive.

### BRIEF DESCRIPTION OF FIGURES

Non-limiting and non-exhaustive examples are described with reference to the following figures.

FIG. 1 is an exploded isometric view of a valve assembly for controlling discharge of bulk material from a container, according to an embodiment of the present disclosure.

FIG. 2 is an exploded isometric view of a valve assembly depicting an alternative embodiment with a separate ring gear component, according to an embodiment of the present disclosure.

FIG. 3 is an isometric view of a circular mounting bracket, according to an embodiment of the present disclosure.

FIG. 4 is an isometric view of an assembled valve assembly, according to an embodiment of the present disclosure.

FIG. 5 is a cross-sectional side view of a valve assembly showing an upper conical valve body and a lower conical valve body in a nested configuration, according to an embodiment of the present disclosure.

FIG. 6 is a cross-sectional end view of a valve assembly showing an upper conical valve body and a lower conical valve body, according to an embodiment of the present disclosure.

FIG. 7 is a cross-sectional view of a valve assembly showing a tapered roller thrust bearing, according to an embodiment of the present disclosure.

FIG. 8 is a perspective view of an assembled valve assembly showing an aperture configuration, according to an embodiment of the present disclosure.

FIG. 9 is a front orthogonal view of a valve assembly mounted to a container, according to an embodiment of the present disclosure.

### DETAILED DESCRIPTION

The following description sets forth exemplary aspects of the present disclosure. It should be recognized, however, that such description is not intended as a limitation on the scope of the present disclosure. Rather, the description also encompasses combinations and modifications to those exemplary aspects described herein.

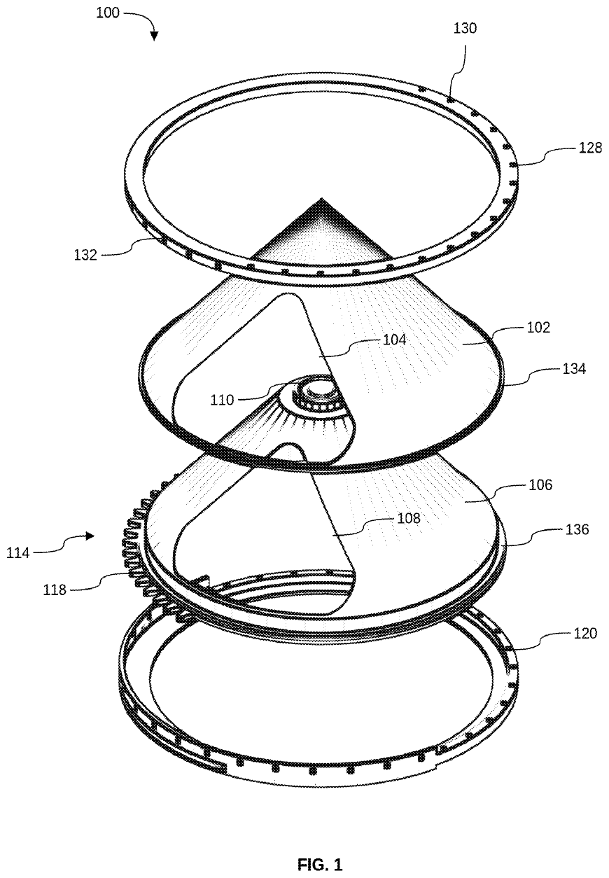

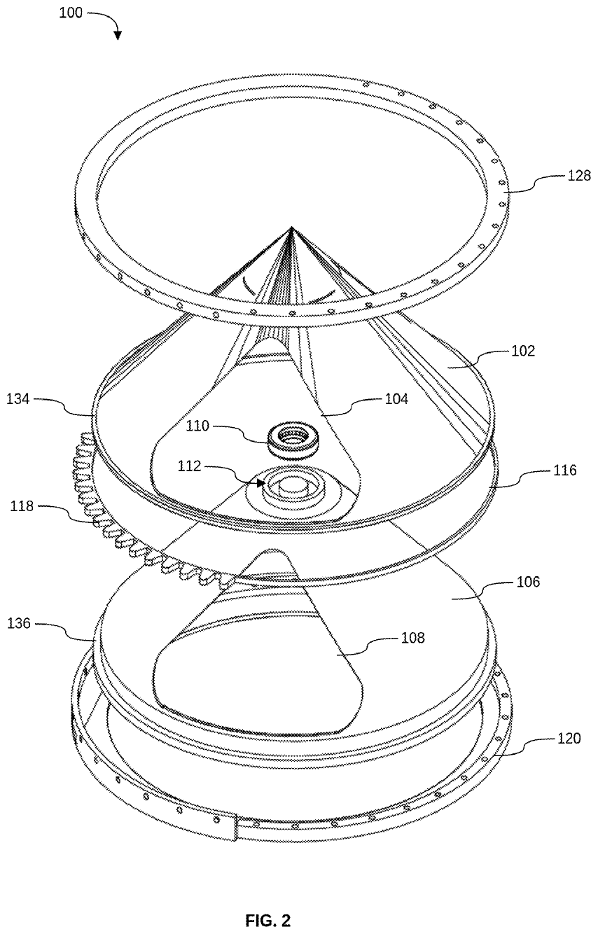

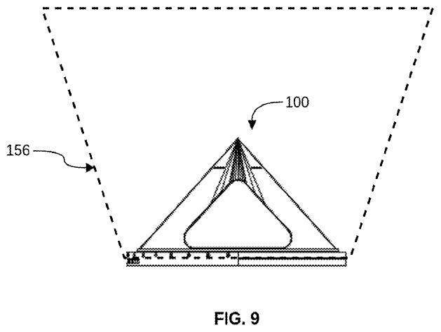

FIG. 1 is an exploded isometric view of a valve assembly 100 for controlling discharge of bulk material from a container 156, according to an embodiment of the present disclosure. FIG. 2 is an exploded isometric view of the valve assembly 100 from an opposing perspective, depicting an alternative embodiment with a separate ring gear component. FIG. 9 is a front orthogonal view of the valve assembly 100 mounted to the container 156. The valve assembly 100 and variations, alternatives, and substitutions thereof are within the scope of the present disclosure.

With reference to FIGS. 1, 2, and 9, the valve assembly 100 includes an upper conical valve body 102, a lower conical valve body 106, a tapered roller thrust bearing 110, a ring gear portion 114 or a ring gear 116 provided as a separate component, a circular mounting bracket 120, a circular holding bracket 128, and a toothed member 138. The valve assembly 100 may be configured to control discharge of bulk material from the container 156 by selectively aligning or misaligning apertures formed in the upper conical valve body 102 and the lower conical valve body 106.

The valve assembly 100 employs a sleeve valve configuration in which the lower conical valve body 106 is nested under and within the upper conical valve body 102. In this nested arrangement, the inclined surfaces of the lower conical valve body 106 are positioned in close proximity to the inclined surfaces of the upper conical valve body 102, such that the lower conical valve body 106 may rotate relative to the upper conical valve body 102 while maintaining contact therebetween. The tapered roller thrust bearing 110 is disposed between the upper conical valve body 102 and the lower conical valve body 106 to facilitate rotational movement of the lower conical valve body 106 relative to the upper conical valve body 102.

As illustrated in FIG. 1, the ring gear portion 114 may be formed integrally with the lower conical valve body 106. The ring gear portion 114 includes cogs 118 extending a portion of a circumference of the ring gear portion 114. As illustrated in FIG. 2, the ring gear 116 may be provided as a separate component configured to be welded or otherwise fixed to the lower conical valve body 106. The ring gear 116 includes cogs 118 configured to engage with the toothed member 138. The toothed member 138 may be a rack configured to engage with the cogs 118 to rotate the lower conical valve body 106 relative to the upper conical valve body 102.

The circular mounting bracket 120 is disposed circumferentially around a base of the upper conical valve body 102 and a base of the lower conical valve body 106. The circular holding bracket 128 includes vertical fastening holes 130 and horizontal fastening holes 132 disposed around a circumference of the circular holding bracket 128. The circular mounting bracket 120 and the circular holding bracket 128 cooperate to retain the upper conical valve body 102 and the lower conical valve body 106 in the nested configuration while permitting rotational movement of the lower conical valve body 106.

The valve assembly 100 provides a shaftless architecture in which the lower conical valve body 106 rotates directly on the tapered roller thrust bearing 110, driven by engagement between the toothed member 138 and the ring gear portion 114 or the ring gear 116 at a base circumference of the lower conical valve body 106. This shaftless configuration provides a discharge path through the valve assembly 100 that is unobstructed by a central shaft or support structure extending through the material flow path. The absence of a central shaft or support structure within the conical valve bodies may reduce material bridging, accumulation, and flow obstruction during discharge operations.

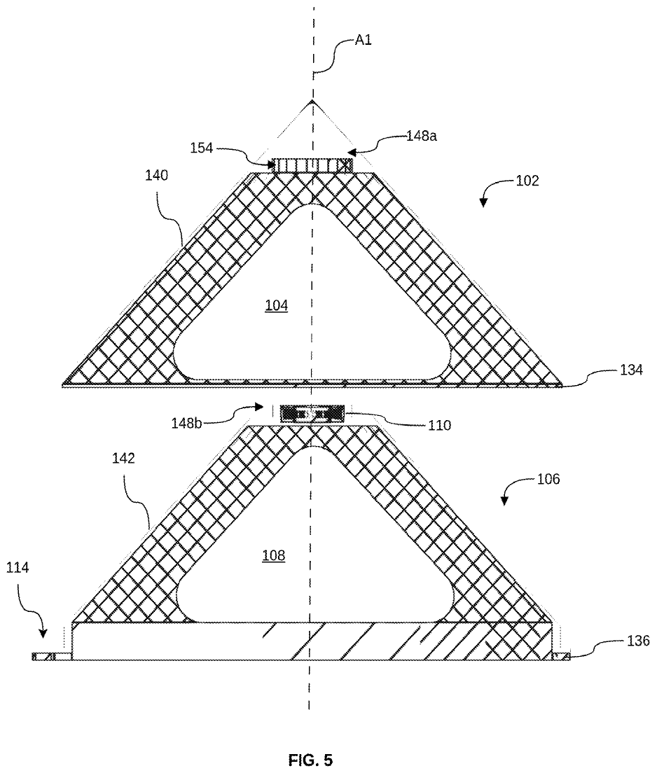

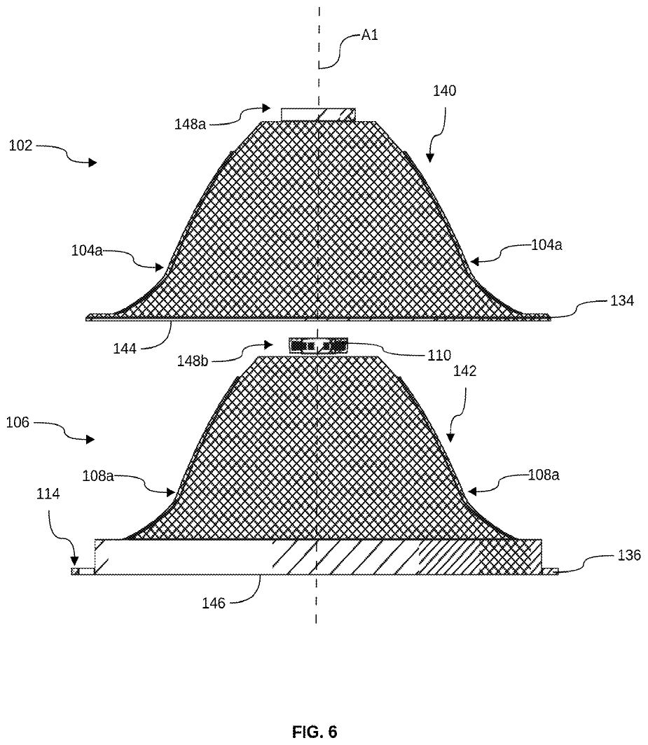

FIGS. 5 and 6 illustrate the upper conical valve body 102 and the lower conical valve body 106 in greater detail. FIG. 5 is a cross-sectional side view showing the nested configuration, and FIG. 6 is a cross-sectional end view showing the valve assembly 100 along a central axis A1. As described above, the upper conical valve body 102 includes at least one aperture disposed on an inclined surface of the upper conical valve body 102, and the lower conical valve body 106 is nested under and within the upper conical valve body 102 and includes at least one aperture disposed on an inclined surface of the lower conical valve body 106. The upper conical valve body 102 and the lower conical valve body 106 each include contoured inclined surfaces that define the conical geometry of the valve assembly 100.

With reference to FIGS. 5 and 6, an inclined surface 140 of the upper conical valve body 102 and an inclined surface 142 of the lower conical valve body 106 are shown. FIG. 6 depicts the cross-sectional end view along the central axis A1, showing the second, opposing aperture 104a of the upper conical valve body 102 and the second, opposing aperture 108a of the lower conical valve body 106, the inclined surface 140 of the upper conical valve body 102, the inclined surface 142 of the lower conical valve body 106, the tapered roller thrust bearing 110, the ring gear portion 114 with cogs 118, the base 144 of the upper conical valve body 102, and the base 146 of the lower conical valve body 106. The inclined surface 140 of the upper conical valve body 102 follows a contour having a relatively steeper incline near an apex region 148a of the upper conical valve body 102, a point of inflection, and a relatively shallower incline toward the base 144 of the upper conical valve body 102. The inclined surface 142 of the lower conical valve body 106 follows a matching contour having a relatively steeper incline near an apex region 148b of the lower conical valve body 106, a point of inflection, and a relatively shallower incline toward the base 146 of the lower conical valve body 106.

The contoured profile of the inclined surface 140 and the inclined surface 142, as visible in the cross-sectional end view of FIG. 6, may provide functional advantages during discharge operations. The steeper incline near the apex region 148a of the upper conical valve body 102 and the apex region 148b of the lower conical valve body 106 may funnel bulk material laterally and downward toward wider portions of the apertures formed in the upper conical valve body 102 and the lower conical valve body 106. The shallower incline near the base 144 and the base 146 may increase the effective opening area of the apertures, thereby providing greater volumetric flow capacity during discharge. The transition between the steeper incline and the shallower incline at the point of inflection may promote continuous material flow without stagnation zones.

The inclined surface 140 of the upper conical valve body 102 and the inclined surface 142 of the lower conical valve body 106 have matching contoured profiles that maintain consistent spacing between the upper conical valve body 102 and the lower conical valve body 106 throughout the nested arrangement. The consistent spacing between the matching contoured profiles may facilitate a weight-based seal when the valve assembly 100 is in the closed position, wherein the weight of bulk material in the container 156 presses the inclined surface 142 of the lower conical valve body 106 against the inclined surface 140 of the upper conical valve body 102. The matching contoured profiles may also facilitate smooth rotation of the lower conical valve body 106 relative to the upper conical valve body 102 by maintaining uniform contact along the inclined surfaces 140, 142.

With continued reference to FIGS. 5 and 6, the apex region 148a of the upper conical valve body 102 and the apex region 148b of the lower conical valve body 106 are located where the upper conical valve body 102 and the lower conical valve body 106 converge at the lowest point of the nested configuration. The upper conical valve body 102 includes an internal shoulder 154 disposed within the apex region 148a. The internal shoulder 154 may be configured to receive a bearing seat and the apex of the lower conical valve body 106, thereby positioning the lower conical valve body 106 concentrically within the upper conical valve body 102 and providing a reference surface for the nested arrangement.

The base 144 of the upper conical valve body 102 and the base 146 of the lower conical valve body 106 define maximum-diameter regions of the respective conical valve bodies. A flange 134 of the upper conical valve body 102 extends radially outward from the base 144, and a flange 136 of the lower conical valve body 106 extends radially outward from the base 146. The flange 134 and the flange 136 are disposed between the circular holding bracket 128 and the circular mounting bracket 120, as illustrated in FIG. 5. The flange 134 and the flange 136 may cooperate with the circular mounting bracket 120 and the circular holding bracket 128 to retain the upper conical valve body 102 in a fixed position while permitting rotational movement of the lower conical valve body 106.

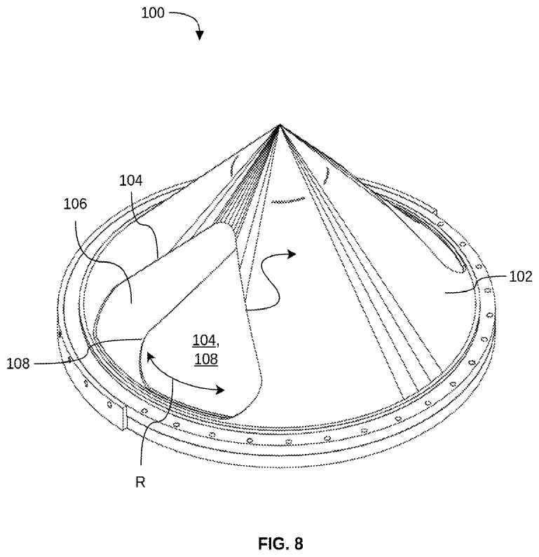

FIG. 8 is a perspective view of the assembled valve assembly 100 showing an aperture configuration. With reference to FIG. 8, the upper conical valve body 102 includes a first aperture 104 and a second, opposing aperture 104a disposed on inclined surfaces of the upper conical valve body 102. The lower conical valve body 106 includes a first aperture 108 and a second, opposing aperture 108a disposed on inclined surfaces of the lower conical valve body 106. The lower conical valve body 106 is configured to undergo a rotation R relative to the upper conical valve body 102 to move the valve assembly 100 between open and closed positions.

The first aperture 104 and the second, opposing aperture 104a of the upper conical valve body 102 may each include a plurality of sides with rounded corners between each side. The first aperture 108 and the second, opposing aperture 108a of the lower conical valve body 106 may each include a plurality of sides with rounded corners between each side. In some cases, the first aperture 104, the second, opposing aperture 104a, the first aperture 108, and the second, opposing aperture 108a may each include three sides with rounded corners between each side. Each aperture may be positioned such that one rounded corner is oriented toward an apex of the respective conical valve body. The rounded corners between each side may reduce stress concentrations at the aperture boundaries, thereby distributing mechanical loads more evenly across the inclined surfaces of the upper conical valve body 102 and the lower conical valve body 106.

The apertures may have a shape that widens from the apex region toward the base of the respective conical valve body. The widening shape may direct a maximum flow area toward the lowest point of each aperture, thereby promoting efficient discharge of bulk material through the valve assembly 100. A lowest side of each aperture may be substantially parallel with a base of the respective conical valve body. As used herein, substantially parallel includes orientations within about ±10° from true parallel. The substantially parallel orientation of the lowest side of each aperture may provide a horizontal bottom edge that facilitates complete cleanout of bulk material during discharge operations.

The upper conical valve body 102 includes two apertures disposed on opposing inclined surfaces of the upper conical valve body 102, and the lower conical valve body 106 includes two apertures disposed on opposing inclined surfaces of the lower conical valve body 106. The dual-aperture configuration creates bilateral symmetry about a central axis of the valve assembly 100. The bilateral symmetry may balance lateral forces acting on the upper conical valve body 102 and the lower conical valve body 106 during discharge, such that bulk material exiting through the first aperture 104 and the first aperture 108 on one side of the valve assembly 100 is counterbalanced by bulk material exiting through the second, opposing aperture 104a and the second, opposing aperture 108a on the opposite side.

When viewed from above or below, the aligned apertures of the upper conical valve body 102 and the lower conical valve body 106 may present an hourglass appearance. The hourglass appearance results from the triangular shape of each aperture with one rounded corner oriented toward the apex and the widening shape extending toward the base of the respective conical valve body.

With continued reference to FIG. 8, the valve assembly 100 is configured to move between an open position and a closed position via the rotation R of the lower conical valve body 106 relative to the upper conical valve body 102. In the open position, the first aperture 104 of the upper conical valve body 102 is aligned with the first aperture 108 of the lower conical valve body 106, and the second, opposing aperture 104a of the upper conical valve body 102 is aligned with the second, opposing aperture 108a of the lower conical valve body 106. The alignment of the apertures in the open position creates a discharge path through which bulk material may flow from the container 156 through the valve assembly 100. In the closed position, the first aperture 104 of the upper conical valve body 102 is not aligned with the first aperture 108 of the lower conical valve body 106, and the second, opposing aperture 104a of the upper conical valve body 102 is not aligned with the second, opposing aperture 108a of the lower conical valve body 106. The misalignment of the apertures in the closed position blocks the discharge path, such that the inclined surfaces of the lower conical valve body 106 cover the apertures of the upper conical valve body 102.

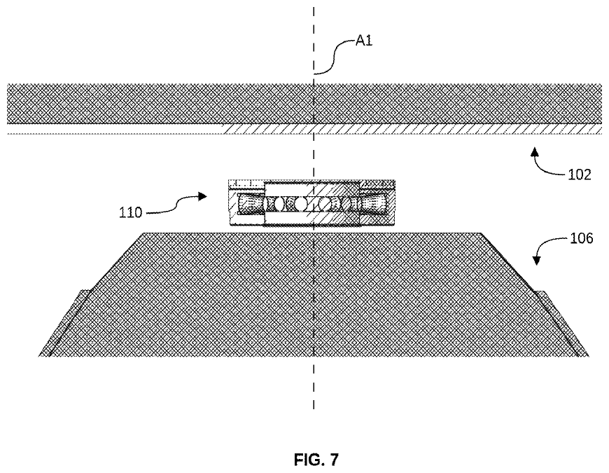

FIG. 7 is a cross-sectional view of the valve assembly 100 showing the tapered roller thrust bearing 110 disposed between the upper conical valve body 102 and the lower conical valve body 106. As described above, the tapered roller thrust bearing 110 is disposed between the upper conical valve body 102 and the lower conical valve body 106 to facilitate rotational movement of the lower conical valve body 106 relative to the upper conical valve body 102. With reference to FIG. 7, the tapered roller thrust bearing 110 includes a plurality of tapered rollers disposed between the upper conical valve body 102 and the lower conical valve body 106.

The lower conical valve body 106 includes a bearing seat 112 formed on a top surface of the lower conical valve body 106 proximate the apex region 148b. The bearing seat 112 is configured to receive the tapered roller thrust bearing 110. In some cases, the tapered roller thrust bearing 110 includes a separate bearing race seated within the bearing seat 112 of the lower conical valve body 106. The apex region 148a of the upper conical valve body 102 rests on the tapered roller thrust bearing 110, such that the tapered roller thrust bearing 110 transfers axial load from the upper conical valve body 102 to the lower conical valve body 106.

The conical geometry of the upper conical valve body 102 and the lower conical valve body 106 concentrates the weight of bulk material in the container 156 downward and radially inward toward the apex region 148a of the upper conical valve body 102 and the apex region 148b of the lower conical valve body 106. The tapered roller thrust bearing 110 handles the combined axial and radial loading resulting from the conical geometry. The tapered rollers of the tapered roller thrust bearing 110 distribute the load across multiple rolling contact points, thereby reducing the rotational torque required to rotate the lower conical valve body 106 relative to the upper conical valve body 102 even when the container 156 is filled with bulk material.

The tapered roller thrust bearing 110 maintains precise vertical spacing between the upper conical valve body 102 and the lower conical valve body 106. The precise vertical spacing provided by the tapered roller thrust bearing 110 may facilitate a consistent weight-based seal between the inclined surfaces of the upper conical valve body 102 and the lower conical valve body 106 when the valve assembly 100 is in the closed position. The precise vertical spacing may also maintain proper contact between the inclined surfaces 140, 142 without binding during rotation of the lower conical valve body 106.

The dimensions of the bearing seat 112 may be variable based on the type of tapered roller thrust bearing 110 selected for a particular application. The bearing seat 112 dimensions may be configured according to customer specifications and manufacturer recommendations for the selected tapered roller thrust bearing 110.

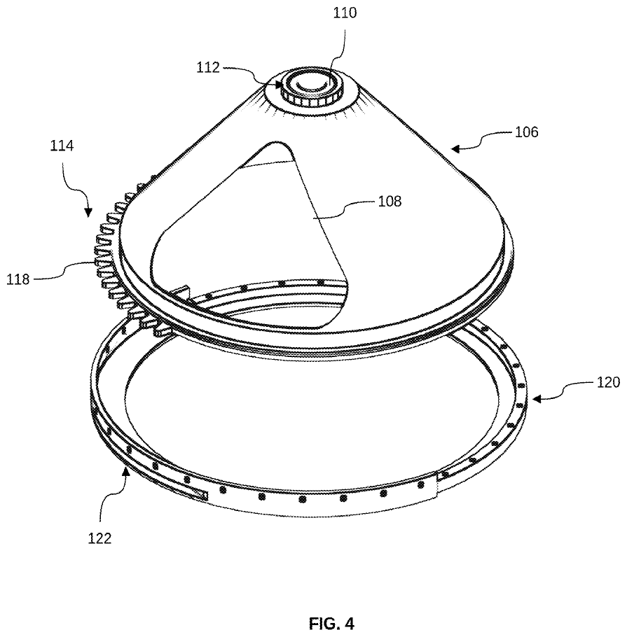

FIG. 4 is an isometric view of the assembled valve assembly 100 showing the ring gear portion 114 and the circular mounting bracket 120. With reference to FIG. 4, the lower conical valve body 106 comprises a ring gear portion 114 configured to engage a toothed member 138 to rotate the lower conical valve body 106 relative to the upper conical valve body 102. The ring gear portion 114 is disposed at the base 146 of the lower conical valve body 106, which defines a maximum-diameter region of the lower conical valve body 106. The positioning of the ring gear portion 114 at the maximum-diameter region may maximize mechanical advantage during rotation of the lower conical valve body 106, such that a given linear displacement of the toothed member 138 produces a corresponding angular displacement of the lower conical valve body 106 with reduced actuation force.

The ring gear portion 114 includes cogs 118 extending a portion of a circumference of the ring gear portion 114. The cogs 118 do not extend around the full circumference of the ring gear portion 114, but rather extend along a portion of the circumference sufficient to accommodate the rotational travel of the lower conical valve body 106 between the open position and the closed position. In the two-aperture embodiment illustrated in FIG. 4, the lower conical valve body 106 may rotate approximately 45 degrees relative to the upper conical valve body 102 to move the valve assembly 100 between the open position and the closed position. In embodiments having smaller apertures or a greater number of apertures disposed around the circumference of the conical valve bodies, the rotational travel may be less than 45 degrees.

In a first configuration, the ring gear portion 114 may be formed integrally with the lower conical valve body 106. The integral formation of the ring gear portion 114 with the lower conical valve body 106 may provide a unitary structure that reduces the number of components in the valve assembly 100. In a second configuration, a ring gear 116 may be provided as a separate component configured to be welded or otherwise fixed to the flange 136 of the lower conical valve body 106. The separate ring gear 116 includes cogs 118 configured to engage with the toothed member 138. The separate ring gear 116 may be attached to the flange 136 via welding, fasteners, adhesive bonding, or other attachment methods.

The circular mounting bracket 120 includes an engagement opening 122 extending a portion of a circumference of the circular mounting bracket 120. At least a portion of the cogs 118 extend through the engagement opening 122 of the circular mounting bracket 120 to engage with the toothed member 138. The engagement opening 122 permits the cogs 118 to extend laterally outward from the ring gear portion 114 or the ring gear 116, such that the toothed member 138 may engage with the cogs 118 from a position external to the circular mounting bracket 120. The external positioning of the toothed member 138 maintains the actuation mechanism outside of the material flow path through the valve assembly 100.

The ring gear portion 114 is configured to engage the toothed member 138 to rotate the lower conical valve body 106 relative to the upper conical valve body 102 between an open position in which the at least one aperture of the upper conical valve body 102 is aligned with the at least one aperture of the lower conical valve body 106 and a closed position in which the at least one aperture of the upper conical valve body 102 is not aligned with the at least one aperture of the lower conical valve body 106. The engagement between the cogs 118 and the toothed member 138 converts linear motion of the toothed member 138 into rotational motion of the lower conical valve body 106, thereby moving the valve assembly 100 between the open position and the closed position.

The toothed member 138 may be configured in various embodiments to engage with the cogs 118 of the ring gear portion 114 or the ring gear 116. In a first embodiment, the toothed member 138 may be a rack. The rack may be a straight rack configured to translate linearly along a line tangent to the circumference of the ring gear portion 114 or the ring gear 116. The straight rack includes a plurality of teeth disposed along a length of the straight rack, the teeth being configured to mesh with the cogs 118. Linear translation of the straight rack in a first direction rotates the lower conical valve body 106 toward the open position, and linear translation of the straight rack in a second, opposite direction rotates the lower conical valve body 106 toward the closed position. The straight rack may be actuated manually by an operator or may be driven by a linear actuator. The linear actuator may be a pneumatic cylinder, a hydraulic cylinder, an electric linear actuator, or other suitable linear motion device. The straight rack configuration provides a straightforward mechanical arrangement with a reduced number of components.

In a second embodiment, the toothed member 138 may be a curved rack. The curved rack follows an arcuate path conforming to the circumference of the ring gear portion 114 or the ring gear 116. The curved rack includes a plurality of teeth disposed along an arc length of the curved rack, the teeth being configured to mesh with the cogs 118 throughout the arcuate travel of the curved rack. The arcuate path of the curved rack maintains consistent engagement between the teeth of the curved rack and the cogs 118 throughout the stroke of the curved rack, such that the meshing depth and contact angle between the teeth and the cogs 118 remain substantially uniform during actuation. The curved rack may be integrated with a handle extending from the curved rack for manual actuation by an operator. The handle may extend radially outward or tangentially from the curved rack to provide leverage for manual operation. The curved rack may be retained within or adjacent to the circular mounting bracket 120, such that the curved rack travels along a guided path during actuation. The curved rack with integrated handle provides a self-contained manual actuation arrangement in which the actuation mechanism remains proximate to the valve assembly 100.

In a third embodiment, the toothed member 138 may be a complementary gear. The complementary gear may be a gear, a pinion, or other rotary toothed member configured for continuous rotation. The complementary gear includes a plurality of teeth disposed around a circumference of the complementary gear, the teeth being configured to mesh with the cogs 118. Rotation of the complementary gear in a first rotational direction rotates the lower conical valve body 106 toward the open position, and rotation of the complementary gear in a second, opposite rotational direction rotates the lower conical valve body 106 toward the closed position. The complementary gear may be driven by an electromechanical actuator. The electromechanical actuator may be an electric motor, a stepper motor, a servo motor, or other rotary drive device. The electromechanical actuator may be electronically and communicatively coupled with a controller via wired signals or wireless signals. The wireless signals may include radio frequency (RF) signals, Bluetooth signals, Wi-Fi signals, or other wireless communication protocols. The controller may transmit command signals to the electromechanical actuator to control the rotational position of the complementary gear, thereby controlling the angular position of the lower conical valve body 106 relative to the upper conical valve body 102.

The complementary gear embodiment may be paired with a continuous-arc engagement opening in the circular mounting bracket 120. The continuous-arc engagement opening extends along a portion of the circumference of the circular mounting bracket 120 sufficient to permit the cogs 118 to remain engaged with the complementary gear throughout the full rotational travel of the lower conical valve body 106 between the open position and the closed position. The continuous engagement between the complementary gear and the cogs 118 enables precise angular positioning of the lower conical valve body 106 for metering applications and variable flow rate control. The controller may command the electromechanical actuator to position the lower conical valve body 106 at intermediate angular positions between the fully open position and the fully closed position, thereby partially aligning the apertures of the upper conical valve body 102 and the lower conical valve body 106 to achieve a desired discharge flow rate. The complementary gear configuration provides fully automated positioning of the valve assembly 100 without manual intervention.

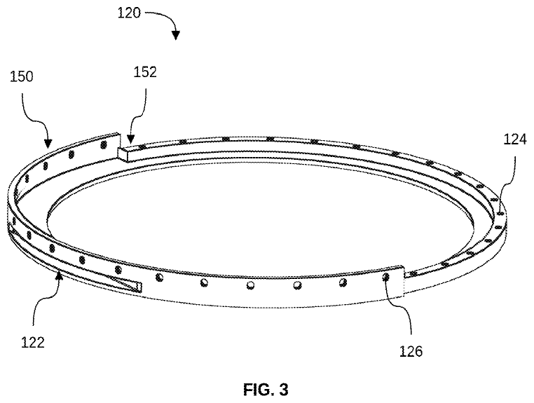

FIG. 3 is an isometric view of the circular mounting bracket 120. As described above, the circular mounting bracket 120 is disposed circumferentially around a base of the upper conical valve body 102 and a base of the lower conical valve body 106. The circular mounting bracket 120 includes an engagement opening 122 extending a portion of a circumference of the circular mounting bracket 120. The circular mounting bracket 120 further includes a plurality of vertical fastening holes 124 and a plurality of horizontal fastening holes 126 disposed around the circumference of the circular mounting bracket 120.

With reference to FIG. 3, the circular mounting bracket 120 includes a vertical facial strap 150 spanning a portion of an outer circumference of the circular mounting bracket 120. The vertical facial strap 150 may span approximately 50% of the outer circumference of the circular mounting bracket 120. The circular mounting bracket 120 further includes a horizontal block 152 disposed on an inner circumference of the circular mounting bracket 120. The horizontal block 152 may be disposed on approximately 50% of the inner circumference of the circular mounting bracket 120, opposite the vertical facial strap 150.

The vertical fastening holes 124 may receive fasteners for securing the circular mounting bracket 120 to a container body or other support structure. The horizontal fastening holes 126 may receive fasteners for coupling the circular mounting bracket 120 to the circular holding bracket 128, such that the circular mounting bracket 120 and the circular holding bracket 128 cooperate to clamp the flange 134 of the upper conical valve body 102 and the flange 136 of the lower conical valve body 106 therebetween.

In one embodiment, the engagement opening 122 may be a discrete window sized to permit rotation of the lower conical valve body 106 between the open position and the closed position. The discrete window configuration of the engagement opening 122 may provide an inherent mechanical stop that limits the rotational travel of the lower conical valve body 106 without requiring separate stop pins or washers. The ends of the discrete window define physical boundaries that contact the cogs 118 at the limits of rotational travel, thereby preventing over-rotation of the lower conical valve body 106 beyond the open position or the closed position.

In an alternative embodiment, the engagement opening 122 may be a continuous arc extending along a portion of the circumference of the circular mounting bracket 120. The continuous arc configuration of the engagement opening 122 may permit continuous rotation of the ring gear portion 114 or the ring gear 116, such that a controller may command discrete incremental movements of the lower conical valve body 106 relative to the upper conical valve body 102. The continuous arc engagement opening 122 may be paired with a complementary gear driven by an electromechanical actuator, enabling precise angular positioning of the lower conical valve body 106 at intermediate positions between the fully open position and the fully closed position for variable flow rate control.

The circular mounting bracket 120 may have an outer diameter of 37.75 inches, an inner diameter of 32.678 inches, and a thickness of 0.375 inches. The dimensions of the circular mounting bracket 120 may be varied based on the size of the valve assembly 100 and the container 156 to which the valve assembly 100 is mounted.

The valve assembly 100 includes a circular holding bracket 128 disposed circumferentially around the base 144 of the upper conical valve body 102 and the base 146 of the lower conical valve body 106. The circular holding bracket 128 includes a plurality of vertical fastening holes 130 disposed around a circumference of the circular holding bracket 128. The vertical fastening holes 130 may receive fasteners for securing the circular holding bracket 128 to the container 156 or to a support structure disposed beneath the container 156. The circular holding bracket 128 further includes a plurality of horizontal fastening holes 132 disposed around the circumference of the circular holding bracket 128. The horizontal fastening holes 132 may receive fasteners for coupling the circular holding bracket 128 to the circular mounting bracket 120.

The circular holding bracket 128 and the circular mounting bracket 120 cooperate to form a clamping assembly that retains the upper conical valve body 102 and the lower conical valve body 106 in the nested configuration. A flange 134 of the upper conical valve body 102 and a flange 136 of the lower conical valve body 106 are disposed between the circular holding bracket 128 and the circular mounting bracket 120. The ring gear portion 114 or the ring gear 116 may also be disposed between the circular holding bracket 128 and the circular mounting bracket 120, such that the clamping assembly captures the flange 134, the flange 136, and the ring gear portion 114 or the ring gear 116 in a sandwiched arrangement.

The clamping assembly formed by the circular holding bracket 128 and the circular mounting bracket 120 may perform multiple functions. In a first function, the clamping assembly secures the upper conical valve body 102 to the container 156 by clamping the flange 134 of the upper conical valve body 102 between the circular holding bracket 128 and the circular mounting bracket 120. The vertical fastening holes 130 of the circular holding bracket 128 and the vertical fastening holes 124 of the circular mounting bracket 120 may receive fasteners that attach the clamping assembly to a bottom wall of the container 156 or to a mounting structure disposed beneath the container 156. In a second function, the clamping assembly constrains the ring gear portion 114 or the ring gear 116 for rotation relative to the upper conical valve body 102. The flange 136 of the lower conical valve body 106 and the ring gear portion 114 or the ring gear 116 are captured between the circular holding bracket 128 and the circular mounting bracket 120, such that the lower conical valve body 106 may rotate about a central axis of the valve assembly 100 while remaining axially constrained within the clamping assembly. In a third function, the engagement opening 122 of the circular mounting bracket 120 provides access for the toothed member 138 to engage with the cogs 118 of the ring gear portion 114 or the ring gear 116, thereby permitting actuation of the lower conical valve body 106 from a position external to the clamping assembly.

The horizontal fastening holes 132 of the circular holding bracket 128 and the horizontal fastening holes 126 of the circular mounting bracket 120 are configured to receive fasteners that couple the circular holding bracket 128 to the circular mounting bracket 120. The fasteners disposed in the horizontal fastening holes 126, 132 may be bolts, screws, or other threaded fasteners that draw the circular holding bracket 128 and the circular mounting bracket 120 together, thereby clamping the flange 134 of the upper conical valve body 102 and the flange 136 of the lower conical valve body 106 therebetween. The vertical fastening holes 124, 130 are configured to receive fasteners that attach the clamping assembly to the container 156 or to a support structure. The dual-axis fastening arrangement provides independent control over the clamping force applied to the flanges 134, 136 and the attachment force securing the clamping assembly to the container 156.

In a primary embodiment, both the flange 134 of the upper conical valve body 102 and the flange 136 of the lower conical valve body 106 are clamped between the circular holding bracket 128 and the circular mounting bracket 120. In alternative embodiments, the upper conical valve body 102 may be secured to the container 156 or to the clamping assembly via other securing means, such as welding, adhesive bonding, threaded engagement, or interference fit. In further alternative embodiments, the lower conical valve body 106 may be retained within the clamping assembly via other securing means that permit rotational movement of the lower conical valve body 106 while constraining axial movement of the lower conical valve body 106.

The circular holding bracket 128 may have an outer diameter of 37.75 inches, an inner diameter of 34.005 inches, and a height of 1 inch. The dimensions of the circular holding bracket 128 may be varied based on the size of the valve assembly 100 and the container 156 to which the valve assembly 100 is mounted.

The nested conical geometry of the valve assembly 100 creates a weight-based seal between the upper conical valve body 102 and the lower conical valve body 106 when the valve assembly 100 is in the closed position. When bulk material is disposed within the container 156, the weight of the bulk material acts downward on the upper conical valve body 102. The conical angle of the inclined surfaces 140, 142 converts the vertical gravitational force into a radial force component directed inward toward a central axis of the valve assembly 100. The radial force component presses the inclined surface 140 of the upper conical valve body 102 against the inclined surface 142 of the lower conical valve body 106 around a full circumference of the nested valve bodies.

The weight-based seal is self-reinforcing, such that a greater load of bulk material in the container 156 produces a tighter seal between the upper conical valve body 102 and the lower conical valve body 106. As the quantity of bulk material in the container 156 increases, the vertical gravitational force acting on the upper conical valve body 102 increases proportionally, and the radial force component pressing the inclined surfaces 140, 142 together increases correspondingly. The self-reinforcing characteristic of the weight-based seal may provide improved sealing performance when the container 156 is filled with bulk material compared to when the container 156 is empty or partially filled.

The weight-based seal may be achieved without separate sealing elements disposed between the upper conical valve body 102 and the lower conical valve body 106. In some embodiments, the valve assembly 100 does not include gaskets, O-rings, or other elastomeric sealing components between the inclined surfaces 140, 142. The metal-to-metal contact between the inclined surface 140 of the upper conical valve body 102 and the inclined surface 142 of the lower conical valve body 106 may provide a seal when the valve assembly 100 is in the closed position and the weight of bulk material presses the inclined surfaces 140, 142 together. The absence of separate sealing elements may reduce the number of components in the valve assembly 100 and may eliminate wear-related replacement of sealing components.

As described above, the tapered roller thrust bearing 110 is disposed between the upper conical valve body 102 and the lower conical valve body 106. The tapered roller thrust bearing 110 maintains precise vertical spacing between the upper conical valve body 102 and the lower conical valve body 106, such that the inclined surfaces 140, 142 remain in proper contact without binding during rotation of the lower conical valve body 106 relative to the upper conical valve body 102. The precise vertical spacing provided by the tapered roller thrust bearing 110 facilitates consistent contact pressure between the inclined surfaces 140, 142 around the full circumference of the nested valve bodies. The tapered roller thrust bearing 110 transfers axial load from the upper conical valve body 102 to the lower conical valve body 106 while permitting low-friction rotational movement between the open position and the closed position.

The valve assembly 100 is configured to move between an open position and a closed position to control discharge of bulk material from the container 156. In the open position, the at least one aperture of the upper conical valve body 102 is aligned with the at least one aperture of the lower conical valve body 106. The alignment of the apertures in the open position creates a discharge path through which bulk material may flow from the container 156 through the valve assembly 100. In embodiments having two apertures disposed on opposing inclined surfaces of the upper conical valve body 102 and two apertures disposed on opposing inclined surfaces of the lower conical valve body 106, rotating the lower conical valve body 106 to the open position includes aligning apertures disposed on opposing inclined surfaces of the upper conical valve body 102 with apertures disposed on opposing inclined surfaces of the lower conical valve body 106. The bilateral alignment of opposing apertures permits bulk material to discharge simultaneously through both sides of the valve assembly 100.

In the closed position, the at least one aperture of the upper conical valve body 102 is not aligned with the at least one aperture of the lower conical valve body 106. The misalignment of the apertures in the closed position blocks the discharge path, such that solid inclined surfaces of the lower conical valve body 106 cover the apertures of the upper conical valve body 102. The solid inclined surfaces of the lower conical valve body 106 that are positioned between the apertures of the lower conical valve body 106 obstruct the apertures of the upper conical valve body 102, thereby preventing bulk material from passing through the valve assembly 100.

The transition between the open position and the closed position is achieved by rotating the lower conical valve body 106 relative to the upper conical valve body 102. As described above, the lower conical valve body 106 is nested under and within the upper conical valve body 102, and a tapered roller thrust bearing 110 is disposed between the upper conical valve body 102 and the lower conical valve body 106. The tapered roller thrust bearing 110 facilitates the rotation of the lower conical valve body 106 relative to the upper conical valve body 102 by reducing friction and distributing axial and radial loads across multiple rolling contact points.

A method of controlling discharge of bulk material from the container 156 includes providing the valve assembly 100 including the upper conical valve body 102 having at least one aperture and the lower conical valve body 106 nested under and within the upper conical valve body 102, the lower conical valve body 106 having at least one aperture, wherein the tapered roller thrust bearing 110 is disposed between the upper conical valve body 102 and the lower conical valve body 106. The method further includes engaging a toothed member 138 with a ring gear portion 114 of the lower conical valve body 106. The method further includes rotating the lower conical valve body 106 relative to the upper conical valve body 102 via the engagement between the toothed member 138 and the ring gear portion 114, wherein the tapered roller thrust bearing 110 facilitates the rotation, to move the valve assembly 100 between the open position in which the at least one aperture of the upper conical valve body 102 is aligned with the at least one aperture of the lower conical valve body 106 and the closed position in which the at least one aperture of the upper conical valve body 102 is not aligned with the at least one aperture of the lower conical valve body 106.

The engagement between the toothed member 138 and the cogs 118 of the ring gear portion 114 converts linear motion of the toothed member 138 into rotational motion of the lower conical valve body 106. Linear translation of the toothed member 138 in a first direction rotates the lower conical valve body 106 in a rotation direction R toward the open position, and linear translation of the toothed member 138 in a second, opposite direction rotates the lower conical valve body 106 in an opposite rotation direction toward the closed position. In embodiments where the toothed member 138 is a complementary gear, rotation of the complementary gear in a first rotational direction rotates the lower conical valve body 106 toward the open position, and rotation of the complementary gear in a second, opposite rotational direction rotates the lower conical valve body 106 toward the closed position.

In the depicted embodiment having two apertures disposed on opposing inclined surfaces of each conical valve body, the lower conical valve body 106 may rotate approximately 45 degrees relative to the upper conical valve body 102 to move the valve assembly 100 between the open position and the closed position. The approximately 45-degree rotational travel corresponds to one-quarter of the angular spacing between adjacent apertures in the two-aperture configuration. In embodiments having smaller apertures or a greater number of apertures disposed around the circumference of the conical valve bodies, the rotational travel between the open position and the closed position may be less than 45 degrees.

During operation, bulk material disposed within the container 156 flows by gravity toward the valve assembly 100. When the valve assembly 100 is in the open position, bulk material passes through the aligned apertures of the upper conical valve body 102 and the lower conical valve body 106 and discharges from the container 156. The flow rate of bulk material through the valve assembly 100 may be controlled by positioning the lower conical valve body 106 at intermediate angular positions between the fully open position and the fully closed position, thereby partially aligning the apertures of the upper conical valve body 102 and the lower conical valve body 106 to achieve a desired discharge flow rate. When the valve assembly 100 is in the closed position, the solid inclined surfaces of the lower conical valve body 106 block the apertures of the upper conical valve body 102, and bulk material is retained within the container 156.

FIG. 9 is a front orthogonal view of the valve assembly 100 mounted to a container 156 for bulk material. The container 156 includes a container body having an interior surface. At least a portion of the interior surface is inclined toward a discharge opening in the container body. The valve assembly 100 is disposed at the discharge opening. The inclined interior surface directs bulk material by gravity toward the discharge opening, where the valve assembly 100 controls the release of bulk material from the container 156.

As described above, the valve assembly 100 includes an upper conical valve body 102 including at least one aperture disposed on an inclined surface of the upper conical valve body 102. A lower conical valve body 106 is nested under and within the upper conical valve body 102. The lower conical valve body 106 includes at least one aperture disposed on an inclined surface of the lower conical valve body 106. A tapered roller thrust bearing 110 is disposed between the upper conical valve body 102 and the lower conical valve body 106. The lower conical valve body 106 comprises a ring gear portion 114 configured to engage a toothed member 138 to rotate the lower conical valve body 106 relative to the upper conical valve body 102 between an open position in which the at least one aperture of the upper conical valve body 102 is aligned with the at least one aperture of the lower conical valve body 106 and a closed position in which the at least one aperture of the upper conical valve body 102 is not aligned with the at least one aperture of the lower conical valve body 106.

In some embodiments, the container body is rigid. Rigid container bodies may be fabricated from metal, fiberglass, plastic, or other suitable materials. Rigid container bodies may include hoppers, silos, bins, railcars, and other vessels designed to store and discharge granular, powdered, or particulate materials, to name but a few examples. In other embodiments, the container body is flexible. Flexible container bodies may include fabric-based vessels such as flexible intermediate bulk containers (FIBCs) or similar flexible storage vessels. The valve assembly 100 may be mounted to either rigid or flexible container bodies using the mounting arrangements described herein.

Flexible container bodies within the scope of the present disclosure may include a variety of materials and constructions. In some aspects, flexible container bodies may be fabricated from woven polypropylene, woven polyethylene, or other woven polymer fabrics. In some cases, flexible container bodies may be fabricated from non-woven textiles, laminated fabrics, or coated fabrics having a polymer or elastomeric coating on one or both surfaces. Flexible container bodies may also include fabric bags constructed from natural fibers, synthetic fibers, or blends thereof. The flexible container body may include reinforced regions, such as lift loops, fill spouts, or discharge spouts, that provide structural attachment points for handling equipment or for interfacing with the valve assembly 100. In some embodiments, the flexible container body may include a rigid or semi-rigid collar, ring, or frame disposed at the discharge opening to provide a stable interface for mounting the valve assembly 100. The circular mounting bracket 120 and the circular holding bracket 128 may be configured to clamp the flexible material of the container body, or a reinforced portion thereof, to secure the valve assembly 100 at the discharge opening. In some cases, the flexible container body may include a sewn, welded, or adhesively bonded seam that attaches the flexible material to a rigid discharge collar configured to receive the valve assembly 100. The flexibility of the container body may permit the container to conform to the shape of the bulk material contained therein or to collapse when empty, while the valve assembly 100 maintains a consistent discharge interface regardless of the fill state of the flexible container.

Bulk materials within the scope of the present disclosure may include a wide variety of granular, powdered, or particulate substances. Agricultural products may include grains, seeds, animal feed, and fertilizers, to name but a few examples. Construction materials may include sand, gravel, cementite, and aggregate. Chemical products may include plastic pellets, resins, and powdered chemicals. Food products may include flour, sugar, salt, and spices. Mining and mineral products may include coal, ore, and mineral powders. Industrial materials may include metal powders, glass beads, and abrasive media. The valve assembly 100 may be configured for use with bulk materials having various particle sizes, ranging from fine powders to coarse granules. The valve assembly 100 may also be configured for use with bulk materials having various densities, flow characteristics, and abrasiveness levels. In some cases, the material selection for the upper conical valve body 102 and the lower conical valve body 106 may be varied based on the abrasiveness or corrosiveness of the bulk material to be handled.

In some embodiments, the container 156 includes a circular mounting bracket 120 and a circular holding bracket 128. The valve assembly 100 is disposed at a bottom wall of the container body. The circular mounting bracket 120 is disposed at or below the bottom wall. The circular mounting bracket 120 and the circular holding bracket 128 cooperate to secure the valve assembly 100 to the container 156 at the discharge opening.

In some embodiments, a bottom wall of the container body is disposed between the circular mounting bracket 120 and the circular holding bracket 128. The bottom wall of the container body may be clamped between the circular mounting bracket 120 and the circular holding bracket 128, such that the valve assembly 100 is secured to the container 156 via the clamping arrangement. The vertical fastening holes 124 of the circular mounting bracket 120 and the vertical fastening holes 130 of the circular holding bracket 128 may receive fasteners that draw the circular mounting bracket 120 and the circular holding bracket 128 together, thereby clamping the bottom wall of the container body therebetween.

In alternative embodiments, the container 156 includes a mounting structure secured to an underside of the container body. The mounting structure supports the valve assembly 100 beneath the container body. The mounting structure may comprise at least one of a circular holding bracket 128 or a separate mounting ring. The separate mounting ring may be a ring-shaped component configured to attach to the underside of the container body and to receive the valve assembly 100. The mounting structure may be welded, bolted, or otherwise affixed to the underside of the container body. The mounting structure may position the valve assembly 100 below the discharge opening of the container body, such that bulk material flows from the container body through the discharge opening and into the valve assembly 100.

The separate mounting ring may be configured to couple to at least one of the circular mounting bracket 120 or the circular holding bracket 128 and the container 156, thereby allowing the valve assembly 100 to be secured to the container 156 in various mounting configurations. In some embodiments, the separate mounting ring may be an annular component having an inner diameter sized to receive the circular mounting bracket 120 or the circular holding bracket 128 and an outer diameter configured for attachment to the underside of the container body. The separate mounting ring may include fastening holes, threaded apertures, or other attachment features disposed around its circumference for receiving fasteners that couple the separate mounting ring to the container body and to the circular mounting bracket 120 or the circular holding bracket 128. In some cases, the separate mounting ring may be welded, bolted, riveted, or adhesively bonded to the underside of the container body. The separate mounting ring may provide an intermediate mounting interface that accommodates variations in container body geometry, wall thickness, or material composition. In alternative embodiments, the separate mounting ring may include a stepped or flanged profile configured to nest with the circular mounting bracket 120 or the circular holding bracket 128. The separate mounting ring may be fabricated from metal, such as steel or aluminum, or from other suitable materials having sufficient strength to support the valve assembly 100 and the weight of bulk material acting thereon. In some aspects, the separate mounting ring may be provided as a retrofit component configured to adapt the valve assembly 100 for installation on existing containers that were not originally designed to receive the valve assembly 100.

The valve assembly 100 may be actuated via a controller or may be manually actuated. In embodiments where the toothed member 138 is a complementary gear driven by an electromechanical actuator, a controller may be communicatively coupled with the electromechanical actuator to control the rotational position of the lower conical valve body 106 relative to the upper conical valve body 102. The method of controlling discharge of bulk material from the container 156 may include actuating the toothed member 138 via a controller to rotate the lower conical valve body 106.

The controller may be communicatively coupled with the electromechanical actuator via wired signals or wireless signals. The wired signals may be transmitted via electrical cables, communication buses, or other suitable wired connections. The wireless signals may include radio frequency (RF) signals, Bluetooth signals, Wi-Fi signals, or other suitable wireless communication protocols. The controller may transmit command signals to the electromechanical actuator to control the angular position of the complementary gear, thereby controlling the angular position of the lower conical valve body 106 relative to the upper conical valve body 102.

The controller may receive input from one or more sensors, timers, or user commands. In some embodiments, the controller may receive input from sensors configured to detect a fill level of bulk material within the container 156, a flow rate of bulk material through the valve assembly 100, or a position of the lower conical valve body 106 relative to the upper conical valve body 102. In some embodiments, the controller may receive input from timers configured to initiate discharge operations at predetermined intervals or for predetermined durations. In some embodiments, the controller may receive input from user commands transmitted via a user interface, a remote control device, or a networked computing device.

The controller may generate control signals to operate the electromechanical actuator in discrete positions or in modulated intermediate positions. In discrete position operation, the controller may command the electromechanical actuator to position the lower conical valve body 106 at the fully open position or the fully closed position. In modulated intermediate position operation, the controller may command the electromechanical actuator to position the lower conical valve body 106 at intermediate angular positions between the fully open position and the fully closed position, thereby partially aligning the apertures of the upper conical valve body 102 and the lower conical valve body 106 to achieve a desired discharge flow rate. The modulated intermediate position operation may enable variable flow rate control for metering applications.

The controller may include or may be associated with a processor, a computer readable medium, a communication unit, data storage such as for example a database network, and a user interface having a display unit. An input/output device, such as a keyboard, touchscreen, or other user interface tool, may be provided so that a human operator may input instructions to the controller. The controller described herein may be a single controller having all of the described functionality, or the controller may include multiple controllers wherein the described functionality is distributed among the multiple controllers.

A “user interface” as used herein may include or otherwise broadly take the form of the display unit and/or other outputs from the system such as indicator lights, audible alerts, and the like. The user interface may further or alternatively include various controls or user inputs such as buttons, switches, levers, or touchscreen controls for operating the valve assembly 100, including operation of the toothed member 138, the electromechanical actuator, and the like.

Such an onboard user interface may be coupled to a valve assembly control system via for example a CAN bus arrangement or other equivalent forms of electrical and/or electro-mechanical signal transmission. Another form of user interface may take the form of a display unit that is generated on a remote user computing device based on signals received via for example a cloud network, which may display outputs such as status indications and/or otherwise enable user interaction such as the providing of inputs to the system. In the context of a remote user interface, data transmission between for example the valve assembly control system and the user interface may take the form of a wireless communications system and associated components as are conventionally known in the art. In certain embodiments, a remote user interface and valve assembly control systems for respective valve assemblies may be further coordinated or otherwise interact with a remote server or other computing device for the performance of operations in a system as disclosed herein.

The controller is configured to receive input signals from various sensors associated with the valve assembly 100. In some embodiments, position sensors may be configured to detect an angular position of the lower conical valve body 106 relative to the upper conical valve body 102. Flow sensors may be configured to detect a discharge rate of bulk material through the valve assembly 100. Load sensors may be configured to detect a weight of bulk material in the container 156. Proximity sensors may be configured to detect whether the valve assembly 100 is in the open position or the closed position. Various of the sensors may typically be discrete in nature, but signals representative of more than one input parameter relevant to the respective positions and/or orientations of the valve assembly components may be provided from the same sensor.

Electronic control signals from the controller may for example be received by the electromechanical actuator to control the actuation thereof in response to the control signal from the controller. In embodiments where the valve assembly 100 includes hydraulic actuators, electronic control signals from the controller may be received by electro-hydraulic control valves associated with respective actuators, wherein the electro-hydraulic control valves control the flow of hydraulic fluid to and from the respective hydraulic actuators to control the actuation thereof in response to the control signal from the controller.

The processor as used herein may refer to at least general-purpose or specific-purpose processing devices and/or logic as may be understood by one of skill in the art, including but not limited to a microprocessor, a microcontroller, a state machine, and the like. A processor can also be implemented as a combination of computing devices, such as a combination of a DSP and a microprocessor, a plurality of microprocessors, one or more microprocessors in conjunction with a DSP core, or any other such configuration.

Various operations, steps or algorithms as described in connection with the controller can be embodied directly in hardware, in a computer program product such as a software module executed by a processor, or in a combination of the two. The computer program product can reside in RAM memory, flash memory, ROM memory, EPROM memory, EEPROM memory, registers, hard disk, a removable disk, or any other form of computer-readable medium known in the art.

The communication unit may support or provide communications between the controller and external systems or devices, for example via a network, and/or support or provide communication interface with respect to internal components of the valve assembly 100. The communication unit may include wireless communication system components such as via cellular modem, WiFi, Bluetooth or the like and/or may include one or more wired communications terminals such as universal serial bus ports.

The data storage as discussed herein may, unless otherwise stated, generally encompass hardware such as volatile or non-volatile storage devices, drives, memory, or other storage media, as well as one or more databases residing thereon.

In alternative embodiments, the method of controlling discharge of bulk material from the container 156 may include manually actuating the toothed member 138 to rotate the lower conical valve body 106. The toothed member 138 may be a straight rack or a curved rack configured for manual actuation by an operator. The straight rack may be translated linearly by an operator to rotate the lower conical valve body 106 between the open position and the closed position. The curved rack may include a handle extending from the curved rack for manual actuation by an operator. The handle may extend radially outward or tangentially from the curved rack to provide leverage for manual operation. The operator may grasp the handle and move the curved rack along an arcuate path to rotate the lower conical valve body 106 between the open position and the closed position.

In some embodiments, the valve assembly 100 may be configured for both controller actuation and manual actuation. The toothed member 138 may be driven by an electromechanical actuator communicatively coupled with a controller during normal operation, and the toothed member 138 may be manually actuated by an operator during maintenance, power loss, or other conditions where controller actuation is unavailable or undesired.

The upper conical valve body and the lower conical valve body may be fabricated from various materials suitable for bulk material handling applications. In some embodiments, the walls of the upper conical valve body and the lower conical valve body may be fabricated from aluminum having a thickness of approximately ⅜ inch. In other embodiments, the walls of the upper conical valve body and the lower conical valve body may be fabricated from steel having a thickness of approximately ⅛ inch. The aluminum and steel wall thicknesses provide suitable strength to resist deformation when foreign materials or compacted bulk material exert localized forces on the inclined surfaces of the conical valve bodies. In alternative embodiments, the upper conical valve body and the lower conical valve body may be fabricated from other metals, alloys, or composite materials having suitable strength and corrosion resistance for the intended application.

The dimensions of the valve assembly components may be varied based on the size of the container and the discharge flow rate requirements of a particular application. In one exemplary embodiment, the upper conical valve body may have a base outer diameter of approximately 35.067 inches and a base inner diameter of approximately 34.005 inches. The lower conical valve body may have a base outer diameter of approximately 33.726 inches and a height of approximately 1.375 inches. The circular holding bracket may have an outer diameter of approximately 37.75 inches, an inner diameter of approximately 34.005 inches, and a height of approximately 1 inch. The circular mounting bracket may have an outer diameter of approximately 37.75 inches, an inner diameter of approximately 32.678 inches, and a thickness of approximately 0.375 inches.

The foregoing dimensions are exemplary and non-limiting. The dimensions of the upper conical valve body, the lower conical valve body, the circular holding bracket, and the circular mounting bracket may be scaled proportionally for larger or smaller container sizes. The wall thicknesses of the conical valve bodies may be increased or decreased based on the weight and abrasiveness of the bulk material to be handled. The dimensions of the circular holding bracket and the circular mounting bracket may be adjusted to accommodate different flange sizes and fastener arrangements.

The valve assembly 100 may be assembled according to a sequence of operations. A tapered roller thrust bearing 110 may be placed in a bearing seat 112 formed on a top surface of the lower conical valve body 106 proximate an apex region 148b of the lower conical valve body 106. In some cases, the tapered roller thrust bearing 110 includes a separate bearing race that is seated within the bearing seat 112 prior to placement of the tapered rollers. The bearing seat 112 receives and retains the tapered roller thrust bearing 110 in a position configured to support the upper conical valve body 102.

The lower conical valve body 106 is nested within the upper conical valve body 102 such that the tapered roller thrust bearing 110 is disposed between an apex region 148a of the upper conical valve body 102 and the apex region 148b of the lower conical valve body 106. The inclined surfaces of the lower conical valve body 106 are positioned in close proximity to the inclined surfaces of the upper conical valve body 102 in the nested arrangement. The tapered roller thrust bearing 110 maintains vertical spacing between the upper conical valve body 102 and the lower conical valve body 106 and permits rotational movement of the lower conical valve body 106 relative to the upper conical valve body 102.

A ring gear portion 114 may be formed integrally with the lower conical valve body 106 at a base circumference of the lower conical valve body 106. In alternative embodiments, a ring gear 116 may be provided as a separate component and attached to a flange 136 of the lower conical valve body 106 via welding, fasteners, adhesive bonding, or other attachment methods. The ring gear portion 114 or the ring gear 116 includes cogs 118 extending a portion of the circumference of the ring gear portion 114 or the ring gear 116.

A flange 134 of the upper conical valve body 102, the flange 136 of the lower conical valve body 106, and the ring gear portion 114 or the ring gear 116 are positioned between a circular holding bracket 128 and a circular mounting bracket 120. The circular holding bracket 128 and the circular mounting bracket 120 are disposed circumferentially around a base 144 of the upper conical valve body 102 and a base 146 of the lower conical valve body 106. The flange 134, the flange 136, and the ring gear portion 114 or the ring gear 116 are sandwiched between the circular holding bracket 128 and the circular mounting bracket 120 in a clamping arrangement.

The circular holding bracket 128 and the circular mounting bracket 120 are fixedly coupled to each other via fasteners disposed through horizontal fastening holes 132 of the circular holding bracket 128 and horizontal fastening holes 126 of the circular mounting bracket 120. The fasteners may be bolts, screws, or other threaded fasteners that draw the circular holding bracket 128 and the circular mounting bracket 120 together, thereby clamping the flange 134 of the upper conical valve body 102 and the flange 136 of the lower conical valve body 106 therebetween. The clamping arrangement secures the upper conical valve body 102 in a fixed position while permitting rotational movement of the lower conical valve body 106 about a central axis of the valve assembly 100.

A toothed member 138 is engaged with the cogs 118 of the ring gear portion 114 or the ring gear 116 through an engagement opening 122 of the circular mounting bracket 120. The engagement opening 122 extends a portion of a circumference of the circular mounting bracket 120 and permits the cogs 118 to extend laterally outward from the ring gear portion 114 or the ring gear 116. The toothed member 138 engages with the cogs 118 from a position external to the circular mounting bracket 120, such that linear or rotational motion of the toothed member 138 is converted into rotational motion of the lower conical valve body 106 relative to the upper conical valve body 102.

A number of implementations have been described. Nevertheless, it will be understood that various modifications may be made without departing from the spirit and scope of the disclosure. Accordingly, other implementations are within the scope of the following claims.

1. A valve assembly for controlling discharge of bulk material from a container, the valve assembly comprising:
an upper conical valve body including at least one aperture disposed on an inclined surface of the upper conical valve body;
a lower conical valve body nested under and within the upper conical valve body, the lower conical valve body including at least one aperture disposed on an inclined surface of the lower conical valve body;
a tapered roller thrust bearing disposed between the upper conical valve body and the lower conical valve body; and
the lower conical valve body comprising a ring gear portion configured to engage a toothed member to rotate the lower conical valve body relative to the upper conical valve body between an open position in which the at least one aperture of the upper conical valve body is aligned with the at least one aperture of the lower conical valve body and a closed position in which the at least one aperture of the upper conical valve body is not aligned with the at least one aperture of the lower conical valve body.

2. The valve assembly of claim 1, wherein the at least one aperture of the upper conical valve body and the at least one aperture of the lower conical valve body each include a plurality of sides with rounded corners between each side.

3. The valve assembly of claim 2, wherein the at least one aperture of the upper conical valve body and the at least one aperture of the lower conical valve body each include three sides with rounded corners between each side, and wherein each aperture is positioned such that one rounded corner is oriented toward an apex of the respective conical valve body.

4. The valve assembly of claim 1, wherein the upper conical valve body includes two apertures disposed on opposing inclined surfaces of the upper conical valve body, and wherein the lower conical valve body includes two apertures disposed on opposing inclined surfaces of the lower conical valve body.

5. The valve assembly of claim 1, further comprising a circular mounting bracket disposed circumferentially around a base of the upper conical valve body and a base of the lower conical valve body, the circular mounting bracket including an engagement opening extending a portion of a circumference of the circular mounting bracket.

6. The valve assembly of claim 5, further comprising a circular holding bracket, wherein a flange of the upper conical valve body and a flange of the lower conical valve body are disposed between the circular holding bracket and the circular mounting bracket.

7. The valve assembly of claim 5, wherein the ring gear portion includes cogs extending a portion of a circumference of the ring gear portion, and wherein at least a portion of the cogs extend through the engagement opening of the circular mounting bracket to engage with the toothed member.

8. The valve assembly of claim 1, wherein the toothed member is a rack.

9. The valve assembly of claim 1, wherein a lowest side of each aperture is substantially parallel with a base of the respective conical valve body.

10. A container for bulk material, comprising:
a container body having an interior surface, at least a portion of the interior surface being inclined toward a discharge opening in the container body; and
a valve assembly disposed at the discharge opening, the valve assembly comprising:
an upper conical valve body including at least one aperture disposed on an inclined surface of the upper conical valve body;
a lower conical valve body nested under and within the upper conical valve body, the lower conical valve body including at least one aperture disposed on an inclined surface of the lower conical valve body;
a tapered roller thrust bearing disposed between the upper conical valve body and the lower conical valve body; and
the lower conical valve body comprising a ring gear portion configured to engage a toothed member to rotate the lower conical valve body relative to the upper conical valve body between an open position in which the at least one aperture of the upper conical valve body is aligned with the at least one aperture of the lower conical valve body and a closed position in which the at least one aperture of the upper conical valve body is not aligned with the at least one aperture of the lower conical valve body.

11. The container of claim 10, wherein the container body is rigid.

12. The container of claim 10, wherein the container body is flexible.

13. The container of claim 10, further comprising a circular mounting bracket and a circular holding bracket, wherein the valve assembly is disposed at a bottom wall of the container body, and the circular mounting bracket is disposed at or below the bottom wall.

14. The container of claim 13, wherein a bottom wall of the container body is disposed between the circular mounting bracket and the circular holding bracket.

15. The container of claim 10, further comprising a mounting structure secured to an underside of the container body, the mounting structure supporting the valve assembly beneath the container body, the mounting structure comprising at least one of a circular holding bracket or a separate mounting ring.

16. A method of controlling discharge of bulk material from a container, the method comprising:
providing a valve assembly including an upper conical valve body having at least one aperture and a lower conical valve body nested under and within the upper conical valve body, the lower conical valve body having at least one aperture, wherein a tapered roller thrust bearing is disposed between the upper conical valve body and the lower conical valve body;
engaging a toothed member with a ring gear portion of the lower conical valve body; and
rotating the lower conical valve body relative to the upper conical valve body via the engagement between the toothed member and the ring gear portion, wherein the tapered roller thrust bearing facilitates the rotation, to move the valve assembly between an open position in which the at least one aperture of the upper conical valve body is aligned with the at least one aperture of the lower conical valve body and a closed position in which the at least one aperture of the upper conical valve body is not aligned with the at least one aperture of the lower conical valve body.

17. The method of claim 16, wherein rotating the lower conical valve body to the open position includes aligning apertures disposed on opposing inclined surfaces of the upper conical valve body with apertures disposed on opposing inclined surfaces of the lower conical valve body.

18. The method of claim 16, wherein a weight of the bulk material in the container creates a seal between the upper conical valve body and the lower conical valve body when the valve assembly is in the closed position.

19. The method of claim 16, further comprising actuating the toothed member via a controller to rotate the lower conical valve body.

20. The method of claim 16, further comprising manually actuating the toothed member to rotate the lower conical valve body.
